(19) United States
(12) Patent Application Publication
(10) Pub. No.: US 2002/0124065 A1
(43) Pub. Date: Sep. 5, 2002

(54) Mobile computing system architecture

(76) Inventors: Michael Ewart Barritt, Cornwall (GB); Vincent Gregori, Cornwall (GB); Judy Clark, Cornwall (GB); Steven Barritt, Cornwall (GB); John William Glazebrook, Cornwall (GB)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/069,259

(22) PCT Filed: Aug. 6, 2001
(86) PCT No.: PCT/GB01/03527

(30) Foreign Application Priority Data
Aug. 5, 2000 (GB) 0019190.8
Dec. 7, 2000 (GB) 0029937.0

(51) Int. Cl. G06F 15/177; G06F 15/16

(52) U.S. Cl. 709/221; 709/203

(57) ABSTRACT

A system for operating plurality of diverse mobile computing devices 200 used by mobile users is described. A subscriber database 150 is provided comprising information about the hardware and/or software capabilities of the mobile units. An application server 100 accesses the subscriber database 150, allowing preparation of an application script from script segments according to the hardware and/or software capabilities of the unit.

A master application 715 in markup language may be used for the preparation of the application script. Applications and data in the form of script can then be downloaded to each mobile computing device and can continue to function offline with periodic synchronization of data and application with information held in an information server database 460.

The present invention relates to the field of mobile computing solutions. A particular embodiment relates to a fully customisable system and software means for coordinating, organising and fulfilling the computing needs of mobile workers.

At the present time, many industries provide mobile workers with mobile computing and communication devices which are used to provide the mobile worker with information they need to carry out their job, and also to store information reporting the tasks they have carried out. Example mobile workers are meter readers, goods delivery workers, travelling salesmen etc. Examples of the type of information would be a list of things to do during the day, customer addresses etc and then confirmation and verification information that tasks had been carried out, time stamps for particular events, new client information, notes etc.

For example, a postal delivery worker might, on a daily basis, download a list of parcels to deliver, where and when they have to be delivered and may, in the course of deliveries, scan parcel bar codes or make records to show that deliveries have been completed at particular times. Typically, these systems require considerable hardware specific programming and implementation. Such systems need customised depending on the nature of the hardware devices carried by mobile workers, the servers organising the system and the networking hardware (e.g. ethernet, telephone network) use for interfacing with mobile units at the beginning and end of the day. As well as the time and expense involved in customisation this means that individual organisations have separate and non-compatible mobile computing solutions.

Recently, internet-based application servers have become a popular method of delivering computing solutions to multiple users. It would be desirable to provide an application server adapted for the needs of companies with mobile workers. However, given the use by different firms of different hardware and software programs it is hard to see how this could be achieved and so an aim of the present invention is to provide application server technology for use in delivering mobile computing solutions to multiple users, being fully internet enabled, customisable and requiring minimal or no configuration by mobile workers.

One aim of the present invention is to provide a system which can be operated using any type of commercially available mobile computing hardware without customisation. In the present system the only action typically required by a user to configure a mobile unit for use with the system is to input one internet address once.

A further aim of the present invention is to provide a means for enabling the system to function when individual mobile communication and computing devices are periodically on and off-line. In one extreme at the present time, mobile computing device have information downloaded into them once per day (e.g. a list of tasks) and uploaded to a central server at the end of the day. In another extreme it is known to provide a web server application which can be accessed online; however, this type of system cannot function when offline and, as it is prohibitively expensive to remain permanently connected, is not financially viable.

Therefore, another aim of the present invention is to enable mobile workers to benefit from the communications possibilities of mobile network communications with a base system, whilst continuing to be able to function seamlessly when said mobile communications networks are unavailable.

A further aim is to gain the benefits of dynamic communication with a remote server without the high costs of, for example, an always on internet connection.

A further aim of the present invention is to provide a worker with access to the task and data information servers belonging to a plurality of third party organisations which have different hardware and software systems.

A yet further aim is to implement the above aims whilst requiring the mobile units to have only standard browser and communications software and hardware.

According to a first aspect of the present invention there is provided a system comprising:

a plurality of mobile units for use by mobile users;

an application server;

communications means for enabling said mobile units to communicate with the application server;

a subscriber database comprising information about the software and/or hardware capabilities of individual mobile units;

a script database comprising equivalent script segments for carrying out particular functions on mobile units with different software and/or hardware capabilities; wherein

the application server is adapted to provide an application script to a mobile unit, said application script being prepared from script segments selected from the script database according to the information about the mobile unit stored in the subscriber database.

Preferably, the system further comprises a master database, said master database having mobile user specific data, said application script further comprising mobile user specific data specific to the mobile user acquired from the master database.

Preferably, a mobile unit stores a copy of said mobile user specific data.

More preferably, a mobile unit edits the copy of said mobile user specific data.

Preferably also, the copy of said mobile user specific data is synchronised with the mobile user specific data stored in the master database.

Most preferably, the application script is synchronised concomitantly with synchronisation of the mobile user specific data.

Typically, the mobile user specific data relates to tasks carried out by said mobile user.

Preferably mobile user specific data relates to tasks which have been or are being carried out by said mobile user.

Preferably, the system further comprises master application program code means which are interpreted by the application server to prepare the application script.

Most preferably, the master application program code means is stored in markup language.

Said mobile units may communicate with the application server over the internet.

Said mobile units may comprise a browser, said browser executing the application script.

According to a second aspect of the present invention there is provided a method comprising the steps of:

acquiring information about the software and/or hardware capabilities of a mobile unit from a subscriber database, the mobile unit being for use by a mobile user; and

preparing an application script customised for the mobile unit from script segments being selected from a script segment database according to the software and/or hardware capabilities of the mobile unit.

Preferably, said application script further comprises data specific to a mobile user acquired from a master database of mobile user specific data.

Preferably also, a mobile unit stores a copy of said data specific to a mobile user.

Preferably, the copy of the data specific to a mobile user is edited by the mobile user.

More preferably, the method further comprises the step of synchronising the copy of the data specific to a mobile user with the data specific to a mobile user stored in the master database.

Preferably, said data specific to a mobile user comprises information concerning tasks to be performed by or which have been performed by said mobile user.

Preferably, said application script is prepared with reference to a master application.

Typically, said master application is stored in the form of a markup language.

A mobile unit may comprise a browser and the application script be executed by said browser.

According to a third aspect of the present invention there is provided a computer program comprising program instructions which, when loaded into a computer, comprise the application server of the system of the first aspect.

According to a fourth aspect of the present invention there is provided a computer program comprising program instructions for causing a computer to perform the process of any of the second aspect.

According to a fifth aspect of the present invention there is provided a computer program comprising the application script of any of the second aspect.

The present invention will now be illustrated with reference to the following figures in which:

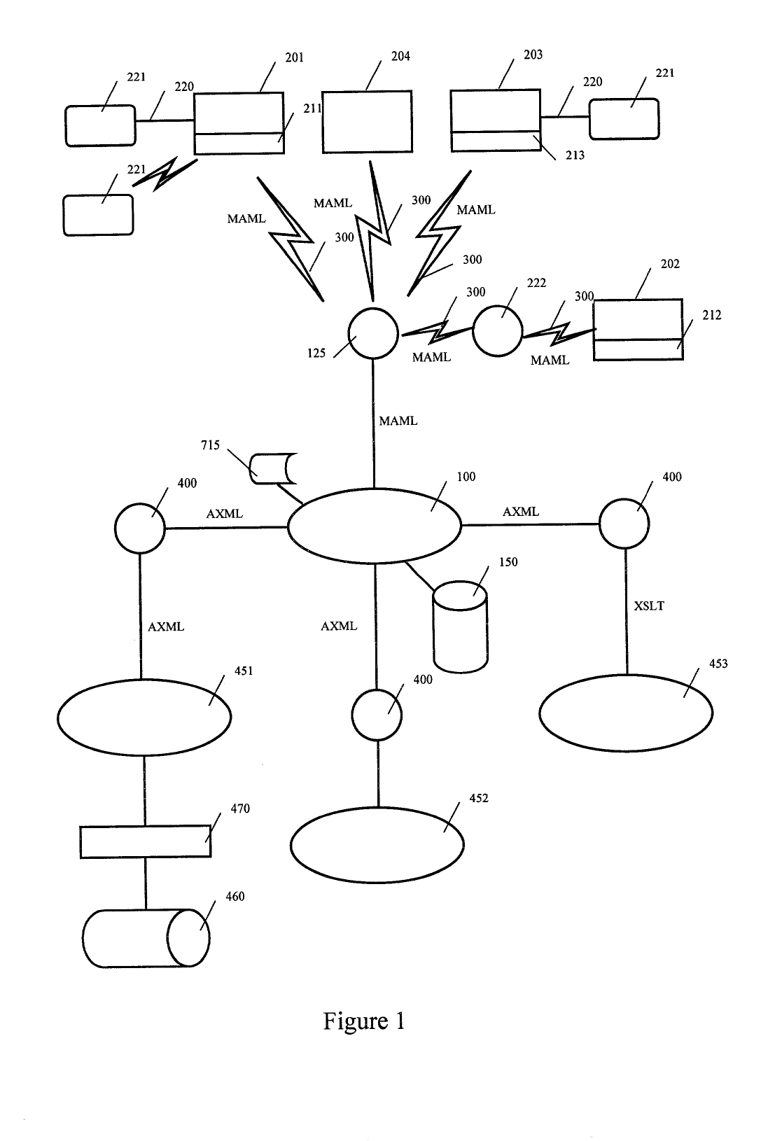

FIG. 1 shows a schematic diagram of overall system architecture;

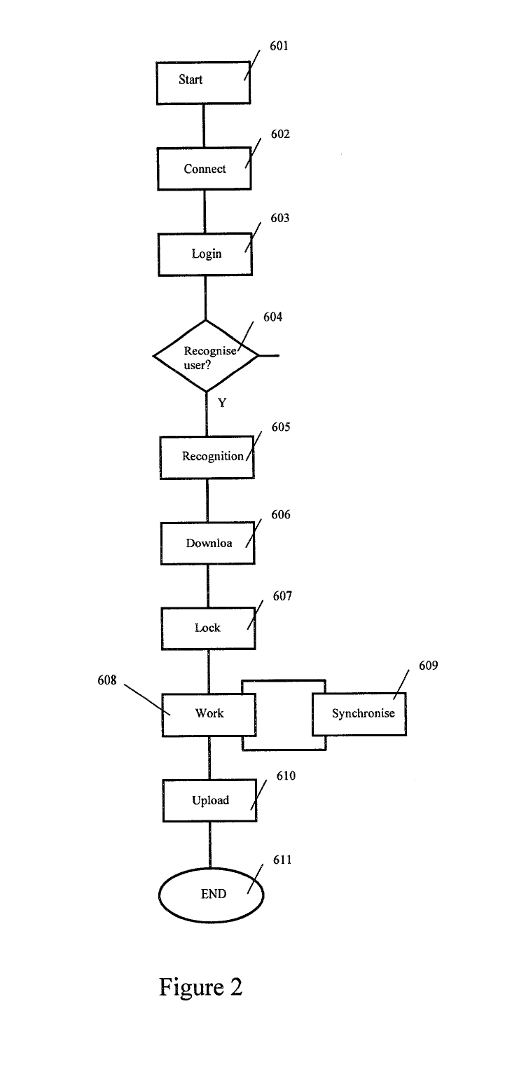

FIG. 2 shows a flow chart of a typical days operations by a mobile worker;

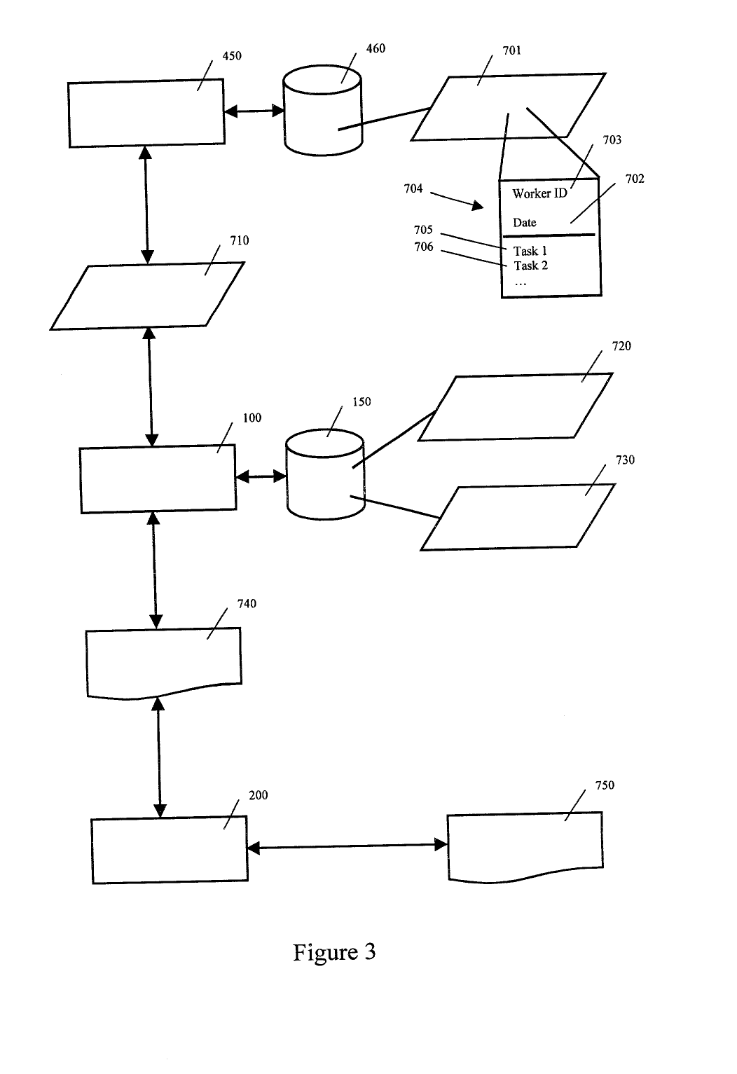

FIG. 3 shows a block diagram of components of a mobile device according to the present invention.

System Overview

FIG. 1 illustrates in block format the individual components of the system and the connectivity between them. The system comprises a web application server 100, and a plurality of mobile computing devices capable of executing scripts shown by way of example as 201-204 and referred to generally as 200. Typically, there are further provided one or more information servers shown by way of example as 451-453 and referred to generally as 450.

The invention comprises program code, usually localised on the web application server, to enable different mobile units to function with the web application server. The invention also comprises one or more applications in a mark-up language, referred to below as mobile application mark-up language (MAML), and the overall methodology and hardware of the system as a whole. MAML Applications dictate mobile device functionality and, in two different embodiments are either (a) interpreted into a script language appropriate to an individual mobile unit with reference to a database 150 of subscriber mobile unit information or (b) transmitted in MAML to the mobile computing devices which have thereon MAML interpreters.

The invention also comprises a further protocol using markup language, here termed Application Extensible Mobile Language (AXML) used for exchange of information between the web application server and information servers.

The mobile devices 200 for use with the system can be of a variety of different types. The requirements of each are that it can communicate with the web application server, downloading and executing scripts and having the capacity to upload data.

Mobile Device Hardware/Software

Example mobile devices 200 would be a Windows CE™ mobile device 201 with JavaScript™ enabled browser 211, a WAP mobile device 202 with WMLScript™ 212 connected through a WAP server 222, a KVM™ mobile device 203 or Java™ virtual machine. Future technologies such as iMode™ and other formats could clearly also be used. In another embodiment an uninterpreted Application in the proprietary format herein referred to as MAML, discussed below can be interpreted by a MAML enabled mobile device 204. Essentially, each mobile device 200 requires the capacity to exchange information with the web application server 100, execute a script and input/output date through a user interface.

Browsers may be supplemented by ActiveX™ components or Java™ Applets on the device to communicate with device specific interfaces 220 for driving peripherals 221, for example, software and hardware interfaces for signature capture systems, scanners, printers, the global positioning system, mobile telephone locating systems etc. This means that the mobile device can be used more or less out of the box with no specific applications or data required.

Mobile devices may for example be in the form of mobile telephones, palmtop organisers, laptop computers, computers integrated into vehicles etc. Users of mobile devices will typically be travelling workers such as salesmen, meter readers, delivery workers, van drivers, factory workers or robots.

In the example embodiment, mobile devices 200 communicate with the central web application server 100 via a network server 125, typically an HTTP server, using TCP/IP. Communication between server 125 and mobile units 200 is through a communications network 300. The communications network 300 could be a fixed PSTN line, LAN or WAN into which mobile units 200 can be connected from time to time, but will preferably be a mobile communications network such as GSM, GPRS or future mobile telephone systems. The mobile device could also be connected to either an Intranet or an Internet via a standard RAS connection using a direct network connection. Information is exchanged between the network server 125 and mobile units 200 using known hardware independent exchange protocols such as TCP/IP. Use of a standard protocol such as TCP/IP allows different physical communications 300 to be readily used with different mobile devices 200. Different types of physical communications network can be integrated as alternatives or consecutively as a data transmission pathway.

Application Server Hardware/Software

The web application server can be implemented in an industry standard development environment and application server for example COLDFUSION™ Usefully COLDFUSION™ can be run on any platform such as Windows NT™, SOLARIS™, LINUX™. The HTTP servers can be implemented using, for example, APACHE™, or other similar servers.

The web application server 100 has access to a subscriber database 150 which comprises information about the hardware and software capabilities, configuration and user data relating to individual subscriber mobile devices showing generally as 200. The subscriber database is describe further below. Typically, the subscriber database is directly connected to the web application server 100; alternatively, information can be stored on information servers or MAML enabled mobile devices 204.

Information Server Hardware/Software

Information server systems comprise typically, an HTTP server 400, an information server. Native or ODBC drivers 470 may be used to interface between an server 451 and associated database 460. Said databases and drivers are readily implemented using common software tools available from, for example, Sybase™, Oracle™, DB2™, SQL server™ etc. Commonly available information servers include those sold by VANMAN™, OPTRAC™ and Systems Union™.

Typically, the central web application server 100 is connected through the internet to one or more information server systems shown by way of example as 451, 452 and 453 and referred to generally as 450. The information servers 450 may belong to the same organisation that owns the web application server 100 or may belong to third party organisations. Importantly, each of these information server systems may be entirely different in internal composition and configuration. The only requirement is that they can communicate with the central web application server in a specified interface format discussed below. The information servers function to provide information required by users of mobile units and to store information returned by them. For example, an information server may comprise information about a list of tasks to be performed on a particular day by a particular mobile user, belonging to a particular organisation which has subscribed to the facility provided by the web application server 100.

Use of System by End User

FIG. 2 shows a flow chart of an example day's use of a mobile communications device and of the systems owned by an individual travelling worker. An important is that the system as a whole can work with different mobile units without them requiring extensive personalisation. The aspect of the system which makes this possible is the ability of the web application server to store in the subscriber information database information about the individual mobile unit and the use of MAML/AXML described below to customise the script sent to the individual mobile unit.

To begin with 601, the mobile communications device connects across a network such as an Intranet or the Internet as discussed above to the central web application server 100. After connecting 602, the device logs in 603 to an information server 450 or central web application server 100, for example, using TCP/IP. The mobile unit might log into a start page defined by a universal resource locator, for example it might connect to a web page belonging to a proprietor/user of an information server 450, preferably this will be the internet address of the web application server 100.

The mobile unit may be pre-set up for a particular user with password etc information. Alternatively, the web application server may use caller line identification, cookies or other identification techniques to establish the user. The user is then either recognised or rejected 604. Upon log-in the system identifies the user 605 and their device as this is part of the user set-up. The subscriber database 150 may contain further information relating to the particular user of the mobile device, such as the type of device they are using, their location, the nature of their business, the type of third party application servers 450 to which they should be allowed access etc. A document is then downloaded 606 from the central web application server and third party application servers 415. The particular information downloaded is based on information held in the central subscriber database 150 and task information stored in third parties databases and servers 450 460.

These can be managed directly from the depot which controls individual projects. For example, it will prescribe a particular series of tasks such as locations we visited, parcels to be dropped off which has been decided by the depot. The information is downloaded in the form of a script comprising both an application and associated data. The script is customised for the particular mobile unit and mobile worker, the application being adapted to function on their particular mobile unit and the data being customised to a particular list of tasks. This customisation is described further below.

At some point after recognition 605 and typically after download or concurrently with download 606, the mobile unit 200 will in some embodiments be locked 607 to prevent access to other functionality. This enables the complete functionality of the hand-held unit to be prescribed, although, for example, a restricted option password may be provided to allow a return to full operating system functionality. The access to other mobile device functionality whilst the programme is running may be varied depending on information held on the subscriber database 150 about the nature of the user and their level of technical sophistication. Locking is not essential but will be preferred for some users.

Next, the user will perform their day's work 608. For example, they will be able to print information such as receipts, print-outs of job tasks etc., look at lists of tasks and associated information. They will be able to read bar code information, read/write to intelligent tags etc. They may be able to capture signatures and other identifying material and transmit these back to base. A benefit of the invention is that instead of them having to perform this upload only at the end of the day or only on-line every time they carry out a transaction, data and application synchronisation can be performed at intervals. Furthermore, they will be able to read credit cards/smart card information, handle complex transaction information such as calculating pricing costs etc offline and will be able to communicate with other devices such as vehicle black boxes, GPS etc 218. Importantly, interface design will be simple and easy to use.

At any point during the day the user will be able to synchronise 609/transmit/download information from the Web application server 100 and information servers. For example, they would be able to transmit information of work that has been completed such as parcels picked up or delivered, and pick up information about new work. As well as just exchanging and synchronising data, the system is also capable of exchanging and synchronising the actual application software running on the mobile unit. Therefore they can readily download updates to software. This feature might be particularly important when they wish to deal with several different third party information services 451, 452 and 453 for which different software will be required.

The term “synchronise” refers to the known process of making two different data sets, such as lists of tasks, correspond in meaning. Typically, the list of tasks in the mobile unit is synchronised with the list of tasks stored in an information server 450 or associated database 460. For example, when the mobile unit has updated a record relating to a particular task, the synchronisation process would involve updating the record in the database 460 with that updated record. Rules can readily be written by one skilled in the art to deal with situations when both records may have changed. Application synchronisation involves ensuring that the application within the mobile unit is the version considered most appropriate by the web application server 100.

At the end of the day the user can then reconnect to the central web application server 100 and upload data 610 concerning their tasks carried out during the day. At that point the day's tasks end 611 and information to do with one journey is finished and another journey can be begun immediately or at a later date. Although one day has been referred to as the duration of an individual journey in this application, it will be clear to one skilled in the art that this could be any period, for example, a few hours or a few days or weeks or even indefinitely.

The above operation routine is common to all potential use of the system, for example van sales, parcel delivery, fuel service etc.

Data Formats

A variety of different information exchange formats are used between different components of the system and several of these are new and important to the functionality of the invention. Importantly, application and data information delivered to individual mobile units is in the form of script in standard mark-up language. Whereas the information delivered and the way in which it operates is new, the underlying software, being delivery of web documents through standard HTTP servers, is standard allowing integration with common known software and hardware implementations. HTTP is used as common protocol for communications and also allows the central web application server 100 to exchange information with other HTTP servers 400, database sources and other devices such as mobile telephones etc.

As discussed above, each mobile device 200 has the capacity to execute a script and input/output data with a user.

The central web application server 100 accepts, validates, authenticates and processes requests from the mobile units 200. Importantly, the central web application servers provides a subscriber database 150 to use in this process. This database contains information on the types of browsers, other software components, subscribers applications and any spoken language translations provided on individual mobile units. The information for the subscriber database can be imported from the information servers 450 or the information servers associated databases 460, or may be maintained standalone and connected directly to the web application server as shown in FIG. 1. Alternatively, the subscriber database can be held in a plurality of locations.

Once requests for information are received from the mobile unit and validated, script is then delivered by the central web application server 100 to the mobile unit 200. Importantly, the central web application server 100 obtains data and application information relevant to the user of the individual handheld unit 200, for example task lists, from the relevant HTTP information server 400 in the form of a specialised version of XML, referred to herein as application extensible mark-up language, AXML.

This data is then combined with application related information which is assembled in the form of mobile application mark-up language, MAML which is a format we have designed to enable the HTML/JavaScript capabilities and mobile browsers (or in the case of WAP browsers, WML/WMLScript) to function with this system. MAML also allows the delivered application to continue running and being used without the browser being connected to the server. It also provides specific functions required on the individual mobile device 200 to make that application easy and fast to use.

Data Flow, MAML Interpretation

FIG. 3 shows an example of the flow of data through the system. In this example, a mobile unit 200 sends an HTTP request to the web application server 100. In response to this the web application server 100 makes a further HTTP request to an information server 450 in AXML for task data relating to the particular user of the mobile unit.

Task related data 701 is stored within a database 750 and in an example format contains header information 704 relating to a particular individual 703 and a particular day 702. The database 750 can be stored on or associated with an information server or in any other location directly or indirectly accessible by the web application server 100. A list of tasks 705, 706 etc is also stored in an appropriate data format as will be clear to one skilled in the art. Example tasks might involve a particular action (deliver a parcel/meet a client/read a meter), identifier information (location for a delivery, identifier for a parcel, miscellaneous information data), time and location information.

Task data can be submitted to the system in numerous ways. For example, it could be held on task information databases associated with third party information servers 450 to enable easy interface with in-house systems. Alternatively, it could be submitted over the internet directly to a task information database associated with the web application server 100. For example, a worker at a factory requiring delivery of a product might use conventional web technology to submit a request to a web site associated with the tasks information databases for said particular product to be delivered. Information might also be supplied by mobile users, during the process of application and data synchronisation or as separate requests.

In response to the request from the web application server 200, the task data record 701 is then processed by the information server 450 and transmitted to the central web application server 100 in the form of an AXML document 710.

An Application 715 for interpretation and delivery to the mobile unit 200 is stored in MAML format, typically on the web server 100 although it can be supplied by information servers 450 or other sources. In order to prepare a script 740 to transmit to the mobile unit, the AXML document 710 and MAML Application 715 are required, along with two different further classes of data records: a subscriber database 720 and script database 730 are usually held within the subscriber database 150. The subscriber database 720 contains information concerning the particular user of a mobile unit 200 and the configuration and capabilities of that unit and peripherals associated therewith. The script database 730 contains hardware and software specific segments of script. Preferably, subscriber database and script database are both in the form of lists.

MAML is interpreted by the web application server 100 by sequentially selecting script segments from script database 730 as appropriate depending on the user information stored in the subscriber database 720. For example, the script segment data records will contain script for common functions e.g. displaying buttons, formatting frames, displaying text etc. in several different formats such as WML Script, JavaScript etc. and the appropriate script segment is selected depending on the type and capabilities of the machine as stored in the user information records 120.

Therefore a script 740 comprising an interpreted application is produced and combined with the data received in AXML format. This is then delivered to the mobile unit 200 where it is executed. As part of the execution process, the copy of the data on the mobile unit 200 can be viewed, amended, edited, deleted or added to. Importantly, this can be carried out whilst the mobile unit 200 is offline.

Whilst it runs offline the data contained within the script can be altered and records containing additional information, such as signatures, notes and timestamps relating to deliveries and events can be stored within for transmission back to the mobile web application server 100 the next time the mobile unit communicates with the web application server 100.

Periodically the mobile unit 200 can request synchronisation and the task data is synchronised with that stored in the task database 460, being reconverted into AXML for transmission to information servers 450.

As a result of this process, information for transmission to/from diverse information servers 450, can be integrated into a standardised form and exchanged with diverse mobile units 200. This allows the owners of the information servers 450 to concentrate on provision of the data being exchanged whereas the owners of the central web application server 100 can concentrate on the front end, user interface and, importantly, adaptation for different software and hardware configurations of mobile unit.

XML data may be converted into different markup formats using the XML document transformation standard XSLT (Extensible Stylesheet Language Transformations) or similar transformation techniques. This may be required to enable particular information servers 450 to communicate with HTTP servers 400.

The present invention has enabled mobile workers to use mobile units with regularly updated applications and information without requiring the costs of an always-on connection or the time limitations of only being able to download/upload information on a daily basis.

Furthermore, the invention enables owners of information servers to maintain their databases without requiring them to additionally take on the complex role of providing access to their databases to mobile users who may have a plurality of different types of device.

This also enables a mobile user 100 to carry out tasks relating to multiple corporations as a single web application server 100 can interface with several information servers 450.

As the invention relates to the overall configuration of the system and the functionality of the central web application server 100, information server 450 and associated databases 150, 460, standard mobile computing devices can be immediately used with the system with minimal or no customisation, providing a cost-effective solution.

In another embodiment, the web application server 100 functionality is fully integrated with an information server 450 and the relevant software may be provided as a module to add functionality to an information server 450.

In further embodiments the information provided to mobile users need not be limited to task related information. The system will be useful wherever data can usefully be distributed to and received from mobile users using diverse mobile units 200. It is particularly beneficial when the ability to keep working on the data when it is offline is useful. For example, it could be applied to the field of computer games. In this embodiment, the web application server 100 or information servers 450 maintain a central database relating to a multiplayer game: e.g. attributes of players, characters, simulated universes etc. in a manner associated with games such as Civilisation™, Age of Empires™, multi user dungeons, Pokemon™ etc. The web application server 100 with reference to the subscriber database 150 enables information relating to the game plus an associated application in the form of a script customised to the particular mobile unit 200 to be delivered to individual players. The downloaded script then allows the player to continue play off-line, using, amending and adding to the stored information which is then synchronised periodically with the central database.

Further modifications and improvements can be made by one skilled within the art within the scope of the invention herein disclosed.

1. A system comprising:
a plurality of mobile units for use by mobile users;
an application server;
communications means for enabling said mobile units to communicate with the application server;
a subscriber database comprising information about the software and/or hardware capabilities of individual mobile units;
a script database comprising equivalent script segments for carrying out particular functions on mobile units with different software and/or hardware capabilities; wherein
the application server is adapted to provide an application script to a mobile unit, said application script being prepared from script segments selected from the script database according to the information about the mobile unit stored in the subscriber database.

2. The system as claimed in claim 1 wherein the system further comprises a master database, said master database having mobile user specific data, and said application script further comprises mobile user specific data specific to the mobile user, acquired from the master database.

3. The system as claimed in claim 2 wherein a mobile unit stores a copy of said mobile user specific data.

4. The system as claimed in claim 3 wherein a mobile unit edits the copy of said mobile user specific data.

5. The system as claimed in claim 3 or claim 4, wherein the copy of said mobile user specific data is synchronised with the mobile user specific data stored in the master database.

6. The system as claimed in claim 5 wherein the application script is synchronised concomitantly with synchronisation of the mobile user specific data.

7. The system as claimed in any of claims 2 to 6 wherein the mobile user specific data relates to tasks carried out by said mobile user.

8. The system as claimed in any of claims 2 to 7 wherein the mobile user specific data relates to tasks which have been or are being carried out by said mobile user.

9. The system as claimed in any preceding claim wherein the system further comprises master application program code means which are interpreted by the application server to prepare the application script.

10. The system as claimed in claim 9 wherein the master application program code means is stored in markup language.

11. The system as claimed in any preceding claim wherein said mobile units communicate with the application server over the internet.

12. The system as claimed in any preceding claim wherein said mobile units comprise a browser, said browser executing the application script.

13. A method comprising the steps of:
acquiring information about the software and/or hardware capabilities of a mobile unit from a subscriber database, the mobile unit being for use by a mobile user; and
preparing an application script customised for the mobile unit from script segments being selected from a script segment database according to the software and/or hardware capabilities of the mobile unit.

14. The method as claimed in claim 13 wherein said application script further comprises data specific to a mobile user acquired from a master database of mobile user specific data.

15. The method as claimed in claim 13 or claim 14 wherein a mobile unit stores a copy of said data specific to a mobile user.

16. The method as claimed in claim 15 wherein the copy of the data specific to a mobile user is edited by the mobile user.

17. The method as claimed in any of claims 14 to 16 wherein the method further comprises the step of:
synchronising the copy of the data specific to a mobile user with the data specific to a mobile user stored in the master database.

18. The method as claimed in any of claims 14 to 17 wherein said data specific to a mobile user comprises information concerning tasks to be performed by or which have been performed by said mobile user.

19. The method as claimed in any of claims 13 to 18 wherein said application script is prepared with reference to a master application.

20. The method as claimed in any of claims 13 to 19 wherein said master application is stored in the form of a markup language.

21. The method as claimed in any of claims 13 to 18 wherein a mobile unit comprises a browser and the application script is executed by said browser.

22. A computer program comprising program instructions which, when loaded into a computer, comprise the application server of the system of any of claims 1 to claim 12.

23. A computer program comprising program instructions for causing a computer to perform the method as claimed in any of claims 13 to 21.

24. A computer program comprising the application script of any of claims 1 to 21.
